(19) United States
(12) Patent Application Publication
(10) Pub. No.: US 2021/0163668 A1
(43) Pub. Date: Jun. 3, 2021

(54) ELECTROACTIVE POLYMERS

(71) Applicant: BASF SE, Ludwigshafen am Rhein (DE)

(72) Inventors: Felicia BOKEL, Lemfoerde (DE); Julia JAEHNIGEN, Bad Essen (DE); Ingolf HENNIG, Ludwigshafen (DE)

(73) Assignee: BASF SE, Ludwigshafen am Rhein (DE)

(21) Appl. No.: 17/046,222

(22) PCT Filed: Apr. 2, 2019
(86) PCT No.: PCT/EP2019/058276

§ 371 Date: Oct. 8, 2020

(30) Foreign Application Priority Data
Apr. 12, 2018 (EP) 18167017.5

(51) Int. Cl. C08G 18/50; C08G 18/48; C08G 18/76; C08G 18/10

(52) U.S. Cl. CPC C08G 18/5096; C08G 18/10; C08G 18/7671; C08G 18/4808

(57) ABSTRACT

A composition may include a polyurethane which is the reaction product of a polyisocyanate, a polyol C1, and a polyol C2, a chain extender, optionally in the presence of a catalyst and/or one or more auxiliaries, wherein the polyol C1 polysiloxane.

The presently claimed invention is directed to a polyurethane which converts mechanical energy into electrical energy or vice versa, also referred to as electroactive polyurethanes.

### BACKGROUND OF THE INVENTION

Electroactive polymers have been reported to be potentially interesting alternatives to common actuator technologies, such as electromagnetic motors, piezoelectric ceramics and solenoids.

The electronic electroactive polymers are bulk insulators that respond to surface charges carried by conductive electrodes patterned on them. The charges apply Coulomb forces to the materials that stress and strain the materials.

EP 2 509 127 describes very generically the use of thermoplastic polyurethanes for the transfer of mechanic energy into electric energy. US 2011/0133598 A1 and U.S. Pat. No. 6,847,153 B1 describe dielectric polyurethanes based on polytetramethylene glycol ether.

It was an object of the present invention to provide polyurethane polymers that feature a beneficial balance of electrical and mechanical properties and can be used to convert mechanical energy into electrical energy or to convert electrical energy into mechanical energy in electromechanical transducers. It is preferred to have flexible and/or soft materials with good mechanical properties, it is additionally preferred to have a high volume resistivity and is also preferred to have a moderate dielectric permittivity.

### SUMMARY OF THE INVENTION

Surprisingly this aim could be achieved by a composition comprising a polyurethane being the reaction product of

a) a polyisocyanate

b) a polyol C1 and a polyol C2

c) a chain extender

eventually in the presence of a catalyst,

the composition eventually further comprising auxiliaries

wherein the polyol C1 is a polysiloxan.

In another aspect, the invention is directed to a film of the composition.

In another aspect, the invention is directed to an electromechanical transducer comprising the film, preferably with a first electrode and a second electrode.

In another aspect, the invention is directed to an actuator, a sensor or a generator comprising the electromechanical transducer.

In another aspect, the presently claimed invention is directed to a method for conversion of mechanical energy into electrical energy or to convert electrical energy into mechanical energy by applying voltage to the composition as defined herein.

### DETAILED DESCRIPTION OF THE INVENTION

Preferably the polyisocyanate has an NCO content in the range of 20 to 55%, more preferably in the range of 20 to 50%.

The polyisocyanate is selected from the group consisting of aliphatic polyisocyanate and aromatic polyisocyanate. It is to be understood that the polyisocyanate includes monomeric and polymeric forms of the polyisocyanate.

Preferred polyisocyanates are aliphatic, cycloaliphatic, araliphatic and/or aromatic isocyanates, further preferred are tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate, 1,4-butylene-diisocyanate, 1-isocyanato-3,3,5-trimethyl-5-isocyanatomethyl-cyclohexane (isophorone diisocyanate, IPDI), 1,4-bis(isocyanatomethyl)cyclohexane and/or 1,3-bis(isocyanatomethyl)cyclohexane (HXDI), 2,4-paraphenylene diisocyanate (PPDI), 2,4-tetramethylene xylene diisocyanate (TMXDI), 4,4′-, 2,4′- and 2,2′-dicyclohexylmethane diisocyanate (H12 MDI), 1,6-hexamethylene diisocyanate (HDI),1,4-cyclohexane diisocyanate, 1-methyl-2,4- and/or -2,6-cyclohexane diisocyanate, 2,2′-, 2,4′- and/or 4,4′-diphenylmethane diisocyanate (MDI), 1,5-naphthylene diisocyanate (NDI), 2,4- and/or 2,6-toluene diisocyanate (TDI), diphenylmethane diisocyanate, 3,3′-dimethyl-diphenyl diisocyanate, 1,2-diphenylethane diisocyanate and/or phenylene diisocyanate.

The polyisocyanate is either a single polyisocyanate or is a mixture of at least two polyisocyanates, preferred is a single polyisocyanate.

More preferably the polyisocyanate is selected form the group consisting of 4,4′-methylene diphenyl diisocyanate; 2,4′-methylene diphenyl diisocyanate; polymeric methylene diphenyl diisocyanate, tolidine diisocyanate, 2,4- and 2,6-toluene diisocyanate, 4,4′-diisocyanatodicyclohexylmethane, hexamethylene 1,6-diisocyanate and, 4,4′-methylene diphenyl diisocyanate which is modified by incorporation of uretonimine.

Very preferred the polyisocyanate is 2,2′-, 2,4′- and/or 4,4′-diphenylmethane diisocyanate (MDI), most preferred the polyisocyanate is 4,4′-diphenylmethane diisocyanate.

Preferably the polyisocyanate is a prepolymer and has an NCO content in the range from 8% to 31.5%, more preferably in the range from 8% to 24%.

The prepolymer preferably is obtained by reacting the polyisocyanate with the polyol C2 at a ratio of the isocyanate groups to hydroxyl groups (NCO/OH ratio) of 2:1 to 20:1, preferably of 8:1.

Chain Extender

In preferred embodiments, organic di- or polyamines or polyols are used as chain extenders.

Chain extenders have a molecular weight preferably less than 450 g/mol, more preferably of 60 to 399 g/mol. The chain extenders have at least two functional groups reactive toward isocyanates, preferably these functional groups are amine groups or hydroxyl groups. The chain extender in one preferred embodiment is used individually, in another preferred embodiment in a mixture comprising at least two chain extenders.

Preference is given to using diols and/or triols having molecular weights of less than 400 g/mol, more preferably of 50 to 399 g/mol, and especially 60 to 150 g/mol. Preferred examples include aliphatic, cycloaliphatic and/or araliphatic chain extenders having 2 to 14 and preferably 2 to 10 carbon atoms. More preferred chain extenders are selected from the group of ethylene glycol, propane-1,3-diol, decane-1,10-diol, 1,2-, 1,3-, 1,4-dihydroxycyclohexane, diethylene glycol, dipropylene glycol and butane-1,4-diol, hexane-1,6-diol and bis(2-hydroxyethyl)hydroquinone, triols such as 1,2,4-, 1,3,5-trihydroxycyclohexane, glycerol and trimethylolpropane, and polyalkylene oxides that contain hydroxyl groups and are based on ethylene oxide and/or 1,2-propylene oxide. In other preferred embodiments the chain extenders are aromatic amines, more preferably selected from the group of di-ethyltoluenediamine, 3,3′-dichloro-4,4′-diaminodiphenylmethane, 3,5-diamino-4-chlorisobutyl benzoate, 4-methyl-2,6-bis(methylthio)-1,3-diaminobenzene, tri-methylene glycol di-p-aminobenzoate. The chain extenders are more preferably selected from the group of monoethylene glycol, 1,3-propylenediol, 1,4-butanediol, diethylene glycol, glycerol, trimethylolpropane, or are mixtures thereof. Even more preferred, the chain extender is selected from 1,3-propanediol and 1,4-butanediol. In one preferred embodiment the chain extender is 1,3-propandiol, and more preferred is used as the only chain extender.

Polyol

The polyurethane polymer is derived polyol C2 and polyol C1.

The polyol C1 and the polyol C2 have, independently of one another, a weight average molecular weight in the range of 400 g/mol to 12×10³ g/mol, preferably in the range of 400 g/mol to 8.0×10³ g/mol, more preferably in the range of 400 g/mol to 6.0×10³ g/mol, preferably determined according to DIN 55672-1.

The polyol C1 and the polyol C2 have, independently of one another, a functionality in the range of 1.5 to 6.0. In a preferred embodiment when the polyurethane is a thermoplastic polyurethane, the functionality of the polyol is in the range of 1.8 to 2.2, more preferably 1.9 to 2.1, more preferred 1.95 to 2.05, and most preferred 2.0.

The polyol C1 and the polyol C2 have a total surface energy in the range of 22 mN/m to 50 mN/m determined according to DIN 55660-3.

Preferably the polyol C1 and polyol C2 each have a total surface energy in the range of 22 mN/m to 47 mN/m, more preferably in the range of 22 mN/m to 41 mN/m, determined according to DIN 55660-3. The polyol C2 is either a single polyol or a mixture of different polyols, in preferred embodiments polyol C2 is a single polyol.

Preferably the polyol C1 and the polyol C2 have, independently of one another, a hydroxyl value in the range of 5 KOH/g to 350 mg KOH/g.

Preferably the polyol C2 is selected from the group consisting of polyether polyols, polycarbonate polyols, polyester polyols and polyolefin polyols. More preferably the polyol C2 is polyester polyol or polyether polyol.

Polyether Polyol

Preferred polyether polyols are obtained by the polymerization of an alkylene oxide, preferably ethylene oxide, propylene oxide, butylene oxide, and tetrahydrofuran. In preferred embodiments the polymerization takes place in the presence of a starter molecule. Preferred starter molecules are selected from the group consisting of water, butanediol, ethylene glycol, propylene glycol, diethylene glycol, triethylene glycol, dipropylene glycol, bisphenol, ethanolamine, diethanolamine, triethanolamine, toluene diamine, diethyl toluene diamine, phenyl diamine, diphenylmethane diamine, ethylene diamine and cyclohexane diamine.

Other preferred polyether polyols include polyether diols and triols, such as polyoxypropylene diols and triols and poly(oxyethylene-oxypropylene)diols and poly(oxyethylene-oxypropylene)triols, preferably obtained by the simultaneous or sequential addition of ethylene and propylene oxides to di- or trifunctional initiators. Copolymers having oxyethylene contents from 5 wt. %, to 90 wt. %, based on the weight of the polyol component, of which the polyols may be block copolymers, random/block copolymers or random copolymers, can also be used.

Preferably polyol C2) comprises the polyether polyol derived from the group consisting of ethylene oxide, propylene oxide, butylene oxide, tetrahydrofuran and a mixture thereof. By the term “derived”, as used herein, it refers to the building block of the polyether polyol.

Particularly preferably, the polyether polyols include polytetramethylene glycols, preferably obtained by the polymerization of the cyclic ether, tetrahydrofuran. This polyether is also referred to as polytetramethylene glycol or α-hydro-ω-hydroxypoly(oxytetra-methylene) diol. These diols in a preferred embodiment have a number average molecular weight in the range of 0.65×10³ g/mol to 6.0×10³ g/mol, more preferably in the range of 0.9×10³ g/mol to 2.5×10³ g/mol, more preferably in the range of 1.5×10³ g/mol to 2.5×10³ g/mol and most preferably in the range of 1.8×10³ g/mol to 2.2×10³ g/mol, preferably determined according to DIN 55672-1. Examples for commercially available polyether polyol include, but are not limited to, PolyTHF® 1000 from BASF.

In a preferred embodiment the polyol C2 is a polyether polyol as described above.

Polycarbonate Polyol

Preferably the polycarbonate polyol has a weight average molecular weight in the range of 0.7×10³ g/mol to 6.0×10³ g/mol, more preferably in the range of 0.8×10³ g/mol to 2.8×10³ g/mol and most preferably in the range of 0.9×10³ g/mol to 2.7×10³ g/mol g/mol, preferably determined according to DIN 55672-1.

Preferably the polycarbonate polyol has a hydroxyl value in the range of 40 to 350 mg KOH/g determined according to DIN 53240.

Preferred polycarbonate polyols are obtained by polycarbonate synthesis of glycols and carbonates. Preferably the polycarbonate polyols are linear and exclusively terminated with hydroxy groups.

In one preferred embodiment the glycol is an aromatic glycol, preferably containing 4 to 40 carbon atoms, and more preferred 4 to 12 carbon atoms.

Preferably the glycol is bisphenol, and more preferably is selected from the group consisting of bisphenol A (2,2-bis(4-hydroxyphenyl)propane); bisphenol AF (1,1-bis(4-hydroxyphenyl)-1-phenylethane), bisphenol AP (1,1-bis(4-hydroxyphenyl)-1-phenylethane), bisphenol B (2,2-bis(4-hydroxyphenyl)butane), bisphenol BP (bis(4-hydroxyphenyl)diphenylmethane), bisphenol C (2,2-bis(3-methyl-4-hydroxyphenyl)propane), bisphenol E (1,1-bis(4-hydroxyphenyl)ethane), bisphenol F (bis(4-hydroxyphenyl)methane), bisphenol FL (9,9-bis(4-hydroxyphenyl)fluorene), bisphenol G (2,2-bis(4-hydroxy-3-isopropylphenyl)propane), bisphenol M (1,3-bis(2-(4-hydroxyphenyl)-2-propyl)benzene), bisphenol P (1,4-bis(2-(4-hydroxyphenyl)-2-propyl)benzene), bisphenol PH (2,2[5,5′-bis[1,1′-(biphenyl)-2-ol]]propane), bisphenol S (bis(4-hydroxyphenyl)sulfone), bisphenol TMC (1,1-bis(4-hydroxyphenyl)-3,3,5-trimethylcyclohexane), and bisphenol Z (1,1-bis(4-hydroxyphenyl)cyclohexane), or is a mixture thereof.

More preferably the glycol is bisphenol A or bisphenol F, or is a mixture thereof.

In another preferred embodiment the glycol is selected from cycloaliphatic and aliphatic diols, preferably containing 4 to 40 carbon atoms, and more preferred 4 to 12 carbon atoms. In one preferred embodiment the glycol is polyoxyalkylene glycols, preferably containing 2 to 20 alkoxy groups per molecule, preferably with each alkoxy group containing 2 to 4 carbon atoms. Other preferred diols are aliphatic diols either linear or cyclic, preferably containing 4 to 12 carbon atoms. The linear aliphatic glycols are preferred. Preferably the linear aliphatic diol is selected from the group consisting of 1,4-butanediol, 1,5-pentanediol, neopentyl glycol, 1,6-hexanediol, 1,6-2,2,4-trimethylhexanediol, 1,10-decanediol, hydrogenated dilinoleylglycol, hydrogenated dioleylglycol. The cyclic yliphatic diol is selected from the group consisting of 1,3-cyclohexanediol, 1,4-dimethylolcyclohexane, 1,4-cyclohexanediol, 1,3-dimethylolcyclohexane, 1,4-endo methylene-2-hydroxy-5-hydroxymethyl cyclohexane, and polyalkylene glycol.

Other suitable carbonates are selected from alkylene carbonates composed of a 5 to 7-member ring. Preferred carbonates are selected from the group consisting of ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate and 2,4-pentylene carbonate. Other preferred carbonates are selected from the group consisting of dialkylcarbonates, cycloaliphatic carbonates and diarylcarbonates. The dialkylcarbonates preferably contain 2 to 5 carbon atoms in each alkyl group and preferred examples thereof are diethylcarbonate and dipropylcarbonate. Cycloaliphatic carbonates, preferably dicycloaliphatic carbonates, preferably contain 4 to 7 carbon atoms in each cyclic structure. Preferred cycloaliphatic carbonates have one or two of such structures. When one structure is cycloaliphatic, the other structure is either alkyl or aryl. On the other hand, if one structure is aryl, the other can be alkyl or cycloaliphatic. Preferred diarylcarbonates contain 6 to 20 carbon atoms in each aryl group. A preferred group is diphenylcarbonate, ditolylcarbonate and dinaphthylcarbonate.

In a preferred embodiment, the polycarbonate polyol is derived from alkanediol selected from the group consisting of butanediol, pentanediol and hexanediol.

In a preferred embodiment the polyol C2 is a polycarbonate polyol as described above.

In another preferred embodiment the polyol C2 is a mixture of a polycarbonate polyol as described above and at least one further polyol as described herein.

Polyesterpolyol

The polyester polyol is the reaction product of polyhydric alcohol and compound selected from the group consisting of dicarboxylic acids, dicarboxylic esters, dicarboxylic ester anhydrides, dicarboxylic acid chlorides or lactones, or the condensation product of lactone.

Preferably the polyester polyol has a weight average molecular weight in the range of 480 to 6000 g/mol, more preferably in the range of 600 g/mol to 3.0×10³ g/mol, determined according to DIN 55672-1.

Preferably the polyester polyol has a hydroxyl value in the range of 10 mg KOH/g to 350 mg KOH/g, more preferably in the range of 30 mg KOH/g to 100 mg KOH/g, determined according to DIN 53240.

Preferably the polyester polyol has a functionality in the range of 2.0 to 4.0, more preferably in the range of 2.0 to 3.0.

Preferably polyhydric alcohols are alkanediols having from 2 to 10, more preferably from 2 to 6, carbon atoms. More preferably the polyhydric alcohol is selected from the group consisting of ethanediol, 1,3-propanediol, 1,4-butanediol, 1,5-pentanediol, 1,6-hexanediol, 1,10-decanediol, 2,2-dimethyl-1,3-propanediol, 2-methyl-1,3-propanediol, 1,2-propanediol, 3-methyl-1,5-pentanediol, and dialkylene ether glycols such as diethylene glycol, dipropylene glycol, 2,2-bis(hydroxymethyl)1,3-propanediol and trimethylolpropane.

Even more preferred the polyhacdric alcohol is selected from the group consisting of ethanediol, 1,4-butanediol, 1,5-pentanediol, and 1,6-hexanediol.

In another preferred embodiment, polyolefin polyol as describe below is used as the polyhydric alcohol.

Preferably the dicarboxylic acids, dicarboxylic esters, dicarboxylic ester anhydrides, dicarboxylic acid chlorides and lactones are selected from the group consisting of phthalic acid; isophthalic acid; terephthalic acid; tetrachlorophthalic acid; maleic acid; dodecylmaleic acid; octadecenylmaleic acid; fumaric acid; aconitic acid; trimellitic acid; tricarballylic acid; 3,3′-thiodipropionic acid; succinic acid; adipic acid; malonic acid, glutaric acid, pimelic acid, sebacic acid, cyclohexane-1,2-dicarboxylic acid; 1,4-cyclohexadiene-1,2-dicarboxylic acid; 3-methyl-3,5-cyclohexadiene-1,2-dicarboxylic acid and the corresponding acid anhydrides such as tetrahydrophthalic anhydride, hexahydrophthalic anhydride, tetrachlorophthalic anhydride, endomethylenetetrahydrophthalic anhydride, acid chlorides and acid esters such as phthalic anhydride, phthaloyl chloride and the dimethyl ester of phthalic acid, dimerized and trimerized unsaturated fatty acids, optionally mixed with monomeric unsaturated fatty acids, terephthalic acid monomethyl ester and terephthalic acid monoglycol ester.

The polyester polyol is preferably prepared be using dicarboxylic acids individually or as mixtures, e.g. in the form of a mixture of succinic acid, glutaric acid and adipic acid. Mixtures of aromatic and aliphatic dicarboxylic acids can likewise be used. To prepare the polyester polyols, it may be advantageous to use the corresponding dicarboxylic acid derivatives such as dicarboxylic esters having from 1 to 4 carbon atoms in the alcohol radical, dicarboxylic anhydrides or dicarboxylic acid chlorides in place of the dicarboxylic acids. The polyester diol is particularly preferably based on adipic acid. In yet another embodiment the polyester polyols are based on ε-caprolactone. Most preferred the polyester is the synthesis product of adipidic acid, ethylene glycol and 1,4 butanediol, the number average molecular weight of this polyester preferably is in the range of 480 g/mol to 3.0×10³ g/mol, more preferably in the range of 1.0×10³ g/mol to 3.0×10³ g/mol, and most preferred in the range of 1.0×10³ g/mol to 2.2×10³ g/mol. All number average molecular weights of this invention are preferably determined according to DIN 55672-1.

In a preferred embodiment the polyol C2 is a polyester polyol as described above.

In another preferred embodiment the polyol C2 is a mixture of a polyester polyol as described above and at least one further polyol as described herein.

Polyolefin Polyol

Preferably the polyolefin polyol has a hydroxyl value in the range of 10 to 560 mg KOH/g, more preferably in the range of 28 to 250 mg KOH/g and most preferably in the range of 28 to 200 mg KOH/g determined according to DIN 53240.

Preferably the polyolefin polyol has a functionality in the range of 1.5 to 5.8, more preferably in the range of 1.7 to 5.0, most preferably the functionality is in the range of 1.85 to 4.5.

Preferably the polyolefin polyol is a hydroxyl-terminated polyolefin polyol. Examples include polybutadiene polyols, polyisoprene polyols, and the like. The polyols can be partially or fully hydrogenated. Polybutadiene polyols, including polybutadiene diols, can be used. Suitable polyolefin polyols are available commercially from Cray Valley Hydrocarbon Specialty Chemicals, a brand of Total, under the Krasol® and Poly bd® trademarks. Examples include Krasol® LBH 2000 and Krasol® LBH 3000, which have secondary hydroxyl groups, and Krasol® LBH-P 2000 and Krasol® LBH-P 3000, which have primary hydroxyl groups. Hydrogenated products include Krasol® HLBH-P 2000 and Krasol® HLBH-P 3000. Other suitable commercial products include Poly bd® R-45HTLO, Poly bd® R-45V, Poly bd® R-20LM, and Poly bd® R-45M.

In some aspects, the polydiene polyol is unsaturated or at least partially unsaturated. The polyolefin polyol preferably has an iodine value within the range of 50 to 500 g/100 g, or from 200 to 450 g/100 g.

In a preferred embodiment the polyol C2 is a polyolefin polyol as described above.

In another preferred embodiment the polyol C2 is a mixture of a polyolefin polyol as described above and at least one further polyol as described herein.

Polysiloxane

In one embodiment of the invention the polyol C1 is a polysiloxane, also referred to as polysiloxane polyol.

The polysiloxane polyol preferably has a surface energy of less than 22 mN/m determined according to DIN 55660-3; preferably the surface energy of the polysiloxan polyol is in the range of 15 mN/m to 21 mN/m; more preferably in the range of 19 to 21 mN/m. The surface energy is preferably determined according to DIN 55660-3.

In case the polysiloxane polyol is used in combination with polyol C2, the total surface energy of the mixture of the polysiloxane polyol and polyol C2 is preferably in the range of 22 to 50 mN/m, more preferably in the range of 22 to 47 mN/m and most preferably in the range of 22 to 41 mN/m.

Preferably the polysiloxane polyol is represented by the general formula (I):

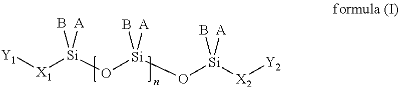

Herein n is an integer ranging from 1 to 250, A and B are independently selected from the group consisting of C1-C20 alkyl groups; X1 is selected from the group consisting of (CH₂—CH₂—O)m group, (CH₂—CH₂—CH₂—O)m group, (CH₂—CHCH₃—O)m group, (CH2)m-O group and (CH₂)m group, X2 is selected from the group consisting of O—(CH₂—CH₂)m group, (O—CHCH₃—CH₂)m group, (O—CH₂—CH₂—CH₂)m group, O—(CH₂)m group and —(CH₂)m group, wherein m for X1, X2 are each independently an integer ranging from 1 to 100; and Y1, Y2 are independently selected from the group consisting of thio group, hydroxyl group and amino group; more preferred Y1 and Y2 are identical groups, even more preferred are hydroxyl groups.

Preferably the polysiloxane polyol has a number average molecular weight in the range of 700 to 3000 g/mol, more preferably in the range of 1200 to 2800 g/mol and most preferably in the range of 1500 to 2800 g/mol determined according to DIN 55672-1.

Preferably the polysiloxane polyol has a hydroxyl value in the range of 11 to 560 mg KOH/g, more preferably in the range of 28 to 250 mg KOH/g and most preferably in the range of 28 to 200 mg KOH/g determined according to DIN 53240.

Preferably the polysiloxane polyol has a functionality in the range of 1.5 to 5.8, more preferably in the range of 1.7 to 5.0, most preferably the functionality is in the range of 1.85 to 4.5.

In a preferred embodiment, n is an integer in the range of 3 to 50 or an integer in the range of 100 to 240.

Preferably, A and B, independently of one another, are each selected from the group consisting of C1-C5 alkyl; more preferably A and B are identically each selected from the group consisting of C1-C5 alkyl and even more preferably A and B are each methyl.

Preferably m is an integer in the range of 1 to 50, more preferably in the range of 1 to 20, more preferably in the range of 1 to 15.

Preferably X₁ is (CH₂—CH₂—O)ₘ, (CH₂—CH₂—CH₂—O)ₘ or (CHCH₃—CH₂—O)ₘ, X₂ is (O—CH₂—CH₂)ₘ, (O—CH₂—CH₂—CH₂)ₘ or (O—CH₂—CHCH₃)ₘ, wherein m is an integer in the range of 1 to 20.

In another embodiment n is an integer in the range of 3 to 50, more preferably in the range of 5 to 40, even more preferably n the range of 10 to 20; X₁ is (CH₂—CH₂—O)ₘ, X₂ is (O—CH₂—CH₂)ₘ, wherein m is an integer in the range of 2 to 20, more preferably m is an integer in the range of 3 to 15.

In another embodiment n is an integer in the range of 3 to 50, more preferably in the range of 10 to 30; X₁ and X₂ are identical (CH₂)ₘ, wherein m is 0 or m is an integer in the range of 1 to 20, more preferably m is an integer in the range of 1 to 10, even more preferably m is 1. Preferably the polysiloxane is polydimethylsiloxane, or is a block copolymer with polydimethylsiloxane (PDMS) and ethylene oxide (EO). In the block copolymer the end preferably comprises EO. In one preferred embodiment the block copolymer preferably comprises 50 weight % to 99 weight % polydimethylsiloxane (PDMS) and 1 weight % to 50 weight % ethylene oxide (EO), more preferably comprises 75 weight % to 99 weight % polydimethylsiloxane (PDMS) and 1 weight % to 25 weight % ethylene oxide (EO), even more preferably comprises 90 weight % to 99 weight % polydimethylsiloxane (PDMS) and 1 weight % to 10 weight % ethylene oxide (EO), IN another embodiment the block copolymer preferably comprises 50 weight % to 70 weight % polydimethylsiloxane (PDMS) and 30 weight % to 50 weight % ethylene oxide (EO), preferably 55 weight % to 65 weight % polydimethylsiloxane (PDMS) and 35 weight % to 45 weight % ethylene oxide (EO).

The most preferred polysiloxane in all embodiments is polydimethylsiloxane.

Chain Extender

The polyurethane polymer that is used according to the present invention in a preferred embodiment is prepared by using a chain extender. The chain extender is either a single chain extender or a mixture of chain extenders, preferred is a single chain extender.

The chain extender preferably has a molecular weight in the range of 50 to 399 g/mol. More preferably the chain extender has a molecular weight in the range of 60 to 350 g/mol. More preferably, the molecular weight is in the range of 60 to 300 g/mol, even more preferably in the range of 60 to 280 g/mol, or 60 to 200 g/mol. Most preferably, the molecular weight is in the range of 60 to 150 g/mol.

The chain extender is preferably a C₂ to C₁₂ alkane diol, or a C₂ to C₆ alkane diol. More preferably the chain extender is selected from the group consisting of ethanediol, 1,3-propanediol, 1,5-pentanediol, 1,6-hexanediol, 1,7-heptanediol, 1,8-octanediol, 1,9-nonanediol, 1,10-decanediol and preferably 1,4-butanediol. Preferred chain extending and/or crosslinking agents further include dialkylene glycols having 4 to 8 carbon atoms, preferably diethylene glycol and dipropylene glycol and/or di-, tri- or tetrafunctional polyoxyalkylene polyols.

The chain extender may further include branched and/or unsaturated alkanediols having preferably not more than 12 carbon atoms, preferably 1,2-propanediol, 2 methylpropanediol-1,3, 2,2-dimethylpropanediol-1,3, 2-butyl-2-ethylpropanediol-1,3, butene-2 diol-1,4 and butyne-2-diol-1,4, diesters of terephthalic acid with glycols of 2 to 4 carbon atoms, preferably terephthalic acid bis-ethylene glycol-1,4 or -butanediol-1,4, hydroxyalkylene ethers of hydroquinone or of resorcinol, preferably 1,4-di(β-hydroxyethyl)hydroquinone or 1,3 di(β-hydroxyethyl)resorcinol, alkanolamines having 2 to 12 carbon atoms, preferably ethanolamine, 2-aminopropanol and 3-amino-2,2-dimethylpropanol, N-alkyldialkanolamines, e.g., N-methyl- and N-ethyldiethanolamine, aromatic amines such as diethyltoluenediamine, 3,3′-dichlor-4,4′-diaminodiphenylmethan, 3,5-diamino-4-chlorisobutylbenzoat, 4-methyl-2,6-bis(methylthio)-1,3-diaminobenzol, trimethylenglykol-di-p-aminobenzoat and 2,4-diamino-3,5-di(methylthio)toluol.

To obtain specific mechanical properties, the alkyl-substituted aromatic polyamines are preferably also used in admixture with the afore mentioned low molecular weight polyhydric alcohols, preferably di- and/or tri-hydric alcohols or dialkylene glycols.

Particularly preferably, the chain extender is selected from the group consisting of ethylene glycol, diethylene glycol, triethylene glycol, 1,3-propanediol, 1,4-butanediol, 1,5-pentanediol, 1,6-hexanediol, hydroquinone bis 2-hydroxyethyl ether, bis-2(hydroxyl ethyl)-terephthalate, glycerine diethylene gylcol, trimethyl propane, 2,4-diamino-3,5-di(methylthio)toluene, and triethanolamine. In a preferred embodiment, the chain extender D) is 1,3-propandio1,1,4-butanediol or ethylene glycol, most preferred chain extender is 1,4-butanediol.

The weight ratio between the polyol C2 or, if present, the polyol C1 and the polyol C2 to the chain extender D) is in the range of 1:1 to 22:1. Preferably, the ratio is in the range of 1.4:1 to 22:1, or 1.4:1 to 21.5:1, or 1.8:1 to 21:1, or 1.8:1 to 20.5:1, or 2:1 to 20.5:1, or 2:1 to 20:1, or 2.4:1 to 20:1, or 2.4:1 to 19.5:1. More preferably, the ratio is in the range of 2.8:1 to 19.5:1, or 2.8:1 to 19:1, or 3:1 to 19:1, or 3:1 to 18.5:1, or 3.4:1 to 18.5:1, or 3.4:1 to 18:1, or 3.8:1 to 18:1, or 3.8:1 to 17.5:1, or 4:1 to 17.5:1, or 4:1 to 17:1. Most preferably, the ratio is in the range of 4.4:1 to 16.5:1, or 4.4:1 to 16.5:1, or 4.8:1 to 16:1, or 4.8:1 to 16:1, or 5:1 to 15.5:1, or 5:1 to 15.5:1, or 5:1 to 15:1. Even most preferably, the ratio is in the range of 5:1 to 14.5:1, or 5:1 to 14:1, or 5:1 to 13.5:1, or 5:1 to 13:1, or 5:1 to 12.5:1, or 5:1 to 12:1, or 5:1 to 11.5:1. In a particularly preferable embodiment, weight ratio between the polyol C2 or, if present, the polyol C1 and the polyol 2) to the chain extender D) is in the range of 5:1 to 11:1.

Catalyst

In a preferred embodiment, the polyurethane polymer of the present invention is prepared in the presence of catalyst.

In a preferred embodiment, the mixture that is used to prepare the polyurethane polymer of the present invention comprises catalyst selected from the group consisting of tin catalysts, amine catalysts, bismuth catalysts, potassium catalysts, nickel catalysts, zirconium catalysts, zinc catalysts, aluminium catalysts and lithium catalysts.

In a preferred embodiment, the amine catalysts are selected from the group consisting of 5-ethyl-2-methylpyridine, 2-methylpyridine, 2,4-dimethylpyridine, 2,6-dimethylpyridine, 2,4,6-trimethylpyridine, tri-n-propylamine, tri-n-butylamine, tris-[2-(2-methoxyethoxy)ethyl]amine, 1,8-diazabicylo[5.4.0]undec-7-ene, 1,5-diazabicyclo[4,3,0]non-5-ene, 1,8-diazabicyclo[5,3,0]dec-7-ene, 1,4-diazabicyclo[3,3,0]oct-4-ene and triethylenediamine. More preferably the amine catalyst is triethylenediamine.

Preferred examples of tin catalysts include dibutyltin dilaurate and stannous octoate; preferred examples of potassium catalysts include potassium octoate; preferred examples of bismuth catalysts include bismuth neodecanoate and representative examples of zinc catalysts include zinc neodecanoate.

In a preferred embodiment, the amount of the catalyst is in the range of 0.00001 wt. % to 5.0 wt. %, preferably in the range of 0.00002 wt. % to 3.0 wt. %, preferably in the range of 0.0005 wt. % to 2.0 wt. %, based on the weight of the isocyanate-reactive component of the system.

Additive

In a preferred embodiment, the polyurethane polymer of the present invention is prepared in the presence of at one additive selected from the group consisting of antifoaming agents, plasticizers, water scavengers, surface-active substances, fillers, flame retardants, nucleators, oxidation inhibitors, lubricating and demolding aids, dyes and pigments, stabilizers, preferably against hydrolysis, light, heat or discoloration, organic and/or inorganic fillers and reinforcing agents.

More preferably the polyurethane polymer of the present invention is prepared in the presence of at one additive selected from the group consisting of antifoaming agents, plasticizers, water scavengers.

In a preferred embodiment, the additive is an antifoaming agent. In one embodiment, the antifoaming agent comprises a silicone fluid including powdered silica dispersed therein. The silicone fluid can be employed to reduce and/or eliminate foaming of the elastomeric composition. It should be appreciated that the silicone fluid may be predisposed in a solvent. Examples of antifoaming agents include Antifoam MSA and Antifoam A, commercially available from Dow Corning of Midland, Mich.

If employed, the antifoaming agent is preferably present in an amount in the range of 0.05 wt. % to 5.0 wt. %, more preferably in the range of 0.05 wt. % to 1.0 wt. %, even preferably in the range of 0.1 wt. % to 0.75 wt. %, based on the weight of the isocyanate-reactive component of the system, i.e. the polyol C2.

In a preferred embodiment the plasticizers are compounds containing carboxylate groups (carboxylic ester groups), such as aromatic carboxylates, in particular C₄-C₁₂-alkyl phthalates, e.g. bis(2-ethylhexyl)phthalate; aliphatic carboxylates, in particular C₄-C₁₂-alkyl adipates, e.g. dioctyl adipate, bis(2-ethylhexyl)adipate or bis(2-ethyloctyl)adipate, or C₄-C₁₂-alkylcitrates, e.g. trisethylcitrate; or cycloaliphatic carboxylates, in particular C₄-C₂₀-alkyl esters of cyclohexane dicarboxylic acids, in particular 1,2-cyclohexane dicarboxylic acid di-C₄-C₂₀-alkyl esters, more particularly 1,2-cyclohexane dicarboxylic acid di-C₄-C₁₂-alkyl esters, specifically 1,2-cyclohexane dicarboxylic acid diisononyl ester (DINCH).

If employed, the plasticizer is preferably present in an amount in the range of 1% to 30 wt. %, more preferably in the range of 5 wt. % to 20 wt. %, even preferably in the range of 5 wt. % to 15 wt. %, based on the weight of the isocyanate-reactive component of the system, i.e. polyol C2.

A water scavenger is a material which is capable of adsorbing water. Preferred water scavengers are zeolite and/or calcium oxide.

If employed, the water scavenger is preferably present in an amount in the range of 0.1% to 10 wt. %, more preferably in the range of 1.0 wt. % to 5.0 wt. %, even preferably in the range of 2.0 wt. % to 4.0 wt. %, based on the weight of the isocyanate-reactive component of the system, i.e. the polyol C2.

Stabilizer

Stabilizers for the purposes of the present invention are additives to protect a plastic or a mixture of plastics from harmful environmental influences. Examples are primary and secondary antioxidants, hindered amine light stabilizers, UV absorbers, hydrolysis control agents, quenchers and flame retardants. Examples of commercial additives are given in Plastics Additive Handbook, 5th Edition, H. Zweifel, ed., Hanser Publishers, Munich, 2001 ([1]), p.98 p.136.

Fillers

Fillers, especially reinforcing fillers, include the customary, familiar organic and inorganic fillers, reinforcing agents and weighting agents. Specific examples are inorganic fillers such as silicatic minerals, for example sheet-silicates such as antigorite, serpentine, hornblendes, amphibols, chrisotile, talc; metal oxides, such as kaolin, aluminum oxides, aluminum silicate, titanium oxides and iron oxides, metal salts such as chalk, barite and inorganic pigments, such as cadmium sulfide, zinc sulfide and also glass particles. Useful organic fillers include for example carbon black, melamine, expandable graphite, rosin, cyclopentadienyl resins, graft polyols and graft polymers.

Fillers in the polyurethane polymer may, for example, regulate the electrical properties such as the dielectric constant of the polyurethane polymer. Examples thereof are ceramic fillers, especially barium titanate, titanium dioxide, and piezoelectric ceramics such as quartz or lead-zirconium titanate, and also organic fillers, especially those with a high electric polarizability, for example phthalocyanines. In addition, a high dielectric constant is also achievable by the introduction of electrically conductive fillers below the percolation threshold thereof. Examples thereof are carbon black, graphite, single-wall or multi-wall carbon nanotubes, electrically conductive polymers such as polythiophenes, polyanilines or polypyrroles, or mixtures thereof.

Organic and inorganic fillers may be used singly or as mixtures and are typically added to the mixture of the present invention in an amount in the range of 0.5 wt.-% to 50 wt.-%, preferably 1 wt.-% to 30 wt.-% based on the total weight of the mixture of the present invention.

Nucleators

As nucleators there may be used, for example, talc, calcium fluoride, sodium phenyl-phosphinate, aluminum oxide and finely divided polytetrafluoroethylene in amounts 5 wt.-%, based on the total weight of the mixture of the present invention.

Oxidaton Retarders

Suitable oxidation retarders and heat stabilizers may be also added to the method of the present invention. These include, for example, halides of metals of group I of the periodic table, e.g., sodium halides, potassium halides, lithium halides, optionally combined with copper(I) halides, e.g., chlorides, bromides or iodides, sterically hindered phenols, hydroquinones, and also substituted compounds of these groups and mixtures thereof, which are preferably used in concentrations 1 wt.-%, based on the total weight of the mixture of the present invention.

Hydrolysis Control

Examples of hydrolysis control agents which may be added to in the method, as described hereinabove, are various substituted carbodiimides, such as preferably 2,2′,6,6′-tetraisopropyldiphenylcarbodiimide or carbodiimides based on 1,3-bis(1-methyl-1 isocyanatoethyl)benzene as described for example in the documents DE 19821668 A1, U.S. Pat. No. 6,184,410, DE 10004328 A1, U.S. Pat. No. 6,730,807, EP 0940389 B1 or U.S. Pat. No 5,498,747, which are generally used in amounts 4.0 wt.-%, preferably in the range of 1.5 wt.-% to 2.5 wt.-%, based on the total weight of the mixture of the present invention.

Lubricating and Demolding Agents

Lubricating and demolding agents, generally preferably added in amounts1 wt.-%, based on the total weight of the mixture of the present invention, are stearic acid, stearyl alcohol, stearic esters and amides and also the fatty acid esters of pentaerythritol.

Dyes

It is further possible to add organic dyes, such as nigrosine, pigments, e.g., titanium dioxide, cadmium sulfide, cadmium sulfide selenide, phthalocyanines, ultramarine blue or carbon black.

Further particulars of the abovementioned auxiliary and added-substance materials are found in the trade literature, for example in Plastics Additive Handbook, 5th edition, H. Zweifel, ed, Hanser Publishers, Munich, 2001, p.98-p.136.

### PREFERRED EMBODIMENTS

In a preferred embodiment the composition comprises a thermoplastic polyurethane (TPU) being the reaction product of

a) a polyisocyanate

b) a polyol C1 and a polyol C2

c) a chain extender

eventually in the presence of a catalyst,

the composition eventually further comprising auxiliaries, wherein the polyol C1 is a polysiloxane, preferably polydimethylsiloxane, the polyol C2 is derived from adipic acid, ethylene glycol and 1,4-butanediol.

Even more preferred the polyisocyanate in this TPU is 4,4′ diphenylmethane-diisocyanate (MDI).

In a preferred embodiment, the number average molecular weight of the adipate polyol is from 1.5×10³ to 2.2×10³ g/mol

In a preferred embodiment the chain extender in this TPU is 1,3-propanediol or 1,4-butanediol, more preferably 1,4-butanediol.

In this TPU the weight ratio of the polyol C1 to polyol C2 ranges from 1:100 to 1:2, more preferably from 1:70 to 1:3, more preferably from 1: 50 to 1:5

In another preferred embodiment the composition comprises a polyurethane 1, being the reaction product of

a) a polyisocyanate

b) a polyol C1 and a polyol C2

c) a chain extender

eventually in the presence of a catalyst,

the composition eventually further comprising auxiliaries, wherein the polyol C1 is a polysiloxane, preferably polydimethylsiloxane, the polyol C2 is preferably polytetrahydrofuran, preferably with a number average molecular weight of 1.5×10³ g/mol to 2.5×10³ g/mol, more preferably 1.8×10³ g/mol to 1.2×10³ g/mol.

Even more preferred the polyisocyanate in this polyurethane 1 is 4,4′-diphenylmethane diisocyanate (MDI).

In a preferred embodiment of this polyurethane 1 the chain extender in this polyurethane is 1,3-propanediol or 1,4-butanediol, more preferably 1,4-butanediol.

In this polyurethane 1 the weight ratio of the polyol C1 to polyol C2 ranges from 1:100 to 1:2, more preferably from 1:70 to 1:3, more preferably from 1:50 to 1:5

In another preferred embodiment the composition comprises a polyurethane 2, being the reaction product of

a) a polyisocyanate

b) a polyol C1 and a polyol C2

c) a chain extender

eventually in the presence of a catalyst,

the composition eventually further comprising auxiliaries, wherein the polyol C1 is a polyalkylendiol as described herein, preferably a polybutadiene diol, the polyol C2 preferably is polytetrahydrofuran, preferably with a number average molecular weight of 0.5×10³ g/mol to 3.05×10³ g/mol, more preferably 1.0×10³ g/mol to 2.0×10³ g/mol.

Even more preferred the polyisocyanate in this polyurethane 2 is 4,4′-diphenylmethane diisocyanate (MDI).

In a preferred embodiment of this polyurethane 2 the chain extender in this polyurethane is 1,3-propanediol or 1,4-butanediol, more preferably 1,4-butanediol.

In this polyurethane 1 the weight ratio of the polyol C1 to polyol C2 ranges from 1:100 to 1:2, more preferably from 1:70 to 1:3, more preferably from 1:50 to 1:5

Use

Another aspect of this invention is the use of a composition according to any of the above described embodiments to convert mechanical energy into electrical energy or to convert electrical energy into mechanical energy.

The composition comprising the polyurethane shows excellent electrical properties. Upon application of an external voltage, its attributes of high dielectric permittivity and low volume resistivity readily allows the the electric field to cause deformation. Preferably the polyurethane polymer according to the presently claimed invention has a dielectric volume resistivity in the range of 1E9 to 1E17 Ω*cm, more preferably in the range of 1E9 to 1E15 Ω*cm, even more preferably in the range of 1E9 to 1E13 Ω*cm, determined according to IEC 62631-3-1 at a voltage of 100 V and measuring resistance 60 seconds after application.

The inventively used polyurethane polymer does not only show excellent electrical properties but also acceptable mechanical properties that allow the use of the polyurethane polymer in the form of a film that can be incorporated in electromechanical transducers.

Preferably the composition comprising the polyurethane invention has a shore A hardness in the range of 25 to 95, more preferably in the range of 30 to 90, even more preferably in the range of 35 to 85, determined according to DIN ISO 7619-1.

Preferably the composition comprising the polyurethane polymer has an elasticity modulus in the range of 0.1 to 50 MPa, more preferably in the range of 0.5 to 40 MPa, even more preferably in the range of 1.0 to 30 MPa, determined according to ASTM D412.

Another aspect of this invention is the composition formed to a film, also referred to as film.

The film can have any useful thickness for the formation of an electromechanical transducer. Preferably the film has a thickness in the range of 10 μm to 5 mm, more preferred 10 μm to 1 mm, more preferred 10 μm to 05 mm, even more preferred 10 μm to 250 μm, more preferably 20 μm to 240 μm, even more preferably 30 μm to 230 μm and most preferably in the range of 40 μm to 220 μm.

Preferably the film has a dielectric permittivity in the range of 3.0 to 15.0, more preferably in the range of 4.0 to 13.0, even more preferably in the range of 4.0 to 11.0, preferably determined according to IEC 60250 at frequency of 1 kHz.

The film is preferably obtained by casting, extrusion, calendaring or injection molding.

The films of the presently claimed invention can also be preferred by using a blend comprising the inventive composition as described above and a second polymer, preferably selected from the group consisting of polyether polyols, polycarbonate polyols, polyester polyols and polyolefin polyols, or mixtures thereof.

The preferred second polymers, preferably the polyols preferably are as described above.

Preferably, the second polymer has a total surface energy in the range of 22 mN/m to 50 mN/m, more preferably in the range of 22 mN/m to 47 mN/m, even more preferably in the range of 22 mN/m to 41 mN/m, preferably determined according to DIN 55660-3. Hence, preferably the blend comprising the composition as described above and the second polymer has a total surface energy in the range of 22 mN/m to 50 mN/m, more preferably in the range of 22 mN/m to 47 mN/m, even more preferably in the range of 22 mN/m to 41 mN/m, preferably determined according to DIN 55660-3.

In a preferred embodiment the film comprising the composition of this invention, in one embodiment is included in an electrochemical transducer. A transducer is a device that can convert electrical energy to mechanical energy or vice versa. A preferred transducer comprises the film as described above, a first electrode and a second electrode.

Suitable electrodes are in principle all materials which have a sufficiently high electrical conductivity and can advantageously follow the expansion of the polyurethane polymer. For example, the electrodes may be formed from an electrically conductive polymer, from conductive ink or from carbon black. Films in the context of the present invention are films which can change their shape through the application of an electric field.

The structure and fabrication of electrochemical transducers and other electrical devices are generally known to those skilled in the art. In another aspect the invention further provides a process for producing an electromechanical transducer comprising the steps of:

1) providing a first electrode and a second electrode;

2) providing a film, said film comprising a polyurethane composition as describe above, and

3) arranging the film between the first electrode and the second electrode.

In one embodiment of the process according to the invention, the film is provided by applying a reaction mixture which produces the polyurethane polymer of the presently claimed invention to the first and/or second electrode. The advantage of this procedure is that the hardening film can build up good adhesion to the electrodes. The reaction mixture can be applied, for example, by knife-coating, painting, pouring, spinning, spraying or extrusion. The reaction mixture is preferably dried and/or heat treated. The drying can be affected within a temperature range from 0° C. to 200° C., for example for 0.1 min to 48 h, especially for 6 h to 18 h. The heat treatment can be effected, for example, within a temperature range from 80° C. to 250° C., for example for 0.1 min to 24 h.

In another aspect, the invention is directed to an actuator, sensor or generator comprising the electrochemical transducer, as described above.

In another aspect, the invention is directed to an electric and/or electronic device comprising the electrochemical transducer, as described above.

In a preferred embodiment the electric and/or electronic device, the actuator, the sensor or the generator includes multiple layers of a film. In one embodiment, all of the multiple layers consist of the composition of the invention. In another embodiment, not all of the multiple layers include the composition of the invention. Preferably an electric and/or electronic device, an actuator, a sensor or a generator comprise 2, 3, 4, 5, 6, 7, 8, 9 or 10 layers comprising the composition of the invention. An exemplary method of fabricating a multilayer device can be found in US 2008/0224566, herein incorporated by reference.

The composition of the presently claimed invention finds use in the electromechanical and electroacoustic sector, especially in the sector of power generation from mechanical vibrations, also referred to as energy harvesting, of acoustics, of ultrasound, of medical diagnostics, of acoustic microscopy, of mechanical sensor systems. Preferred embodiments the composition are used for pressure, force and/or strain sensor systems. These systems are preferably used for robotic systems and/or of communications technology. Preferred examples are pressure sensors, electroacoustic transducers, microphones, loudspeakers, vibration transducers, light deflectors, membranes, modulators for glass fiber optics, pyroelectric detectors, capacitors and control systems and “intelligent” floors, and systems for converting water wave power, especially sea wave power, to electrical energy.

The present invention is illustrated in more detail by the following embodiments and combinations of embodiments which result from the corresponding dependency references and links:
1. Use of a polyurethane polymer comprising the reaction product of
   a mixture comprising
   at least one polyisocyanate A1) and/or
   at least one polyisocyanate prepolymer B) comprising the reaction product of at least one polyisocyanate A2) and at least one polyol C1,
   at least one polyol C2 and
   at least one chain extender D)
   wherein at least one polyol C1 and at least one polyol C2 have, independently of one another, a weight average molecular weight in the range of ≥400 to ≤12000 g/mol determined according to DIN 55672-1
   and at least one of at least one polyol Cl and at least one polyol C2 has a total surface energy in the range of ≥22 to ≤50 mN/m determined according to DIN 55660-3, to convert mechanical energy into electrical energy or to convert electrical energy into mechanical energy.
2. The use according to embodiment 1, wherein at least one polyisocyanate A1) has an NCO content in the range of ≥20 to ≤55%.
3. The use according to embodiment 1 or 2, wherein at least one polyisocyanate prepolymer B) has an NCO content in the range of ≥8 to ≤31.5%.
4. The use according to one or more of embodiments 1 to 3, wherein at least one polyisocyanate A1) and at least polyisocyanate A2) are, independently of one another, selected form the group consisting of toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproplyphenylene-2,4-diisocyanate; 3,3′-diethyl-bisphenyl-4,4′-diisocyanate; 3,5,3′,5′-tetraethyldiphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate and 1,3,5-triisopropyl benzene-2,4,6-triisocyanate, all of which are optionally modified by incorporation of uretdione, isocyanurate, allophanate and uretonimine groups; tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocyanatomethylcyclohexane isocyanates, isocyanatoethylcyclohexane isocyanates, bis(isocyanatomethyl)-cyclohexane diisocyanates, 4,4′-diisocyanatodicyclohexylmethane, hexamethylene 1,6-diisocyanate, pentamethylene 1,5-diisocyanate and isophorone diisocyanate.
5. The use according to embodiment 4, wherein at least one polyisocyanate A1) and at least polyisocyanate A2) are, independently of one another, selected form the group consisting of methylene diphenyl diisocyanate; polymeric methylene diphenyl diisocyanate and methylene diphenyl diisocyanate which is modified by incorporation of uretonimine.
6. The use according to one or more of embodiments 1 to 5, wherein at least one polyol C1 has a weight average molecular weight in the range of ≥400 to ≤8000 g/mol determined according to DIN 55672-1.
7. The use according to one or more of embodiments 1 to 6, wherein at least one polyol C2 has a weight average molecular weight in the range of ≥400 to ≤8000 g/mol determined according to DIN 55672-1.
8. The use according to one or more of embodiments 1 to 7, wherein at least one polyol C1 and at least one polyol C2 have, independently of one another, a total surface energy in the range of ≥22 to ≤47 mN/m determined according to DIN 55660-3.
9. The use according to one or more of embodiments 1 to 8, wherein at least one polyol C1 and at least one polyol C2 have, independently of one another, a hydroxyl value in the range of 5 to 350 mg KOH/g.
10. The use according to one or more of embodiments 1 to 9, wherein at least one polyol C1 and at least one polyol C2 have, independently of one another, a functionality in the range of 1.5 to 6.0.
11. The use according to one or more of embodiments 1 to 10, wherein at least one polyol C1 and C2 are, independently of one another, selected from the group consisting of polyether polyols, polycarbonate polyols, polyester polyols and polyolefin polyols.
12. The use according to embodiment 11, wherein the polyether polyol is selected from the group consisting of polytetramethylene ether glycols, polyoxypropylene diols, polyoxypropylene triols, polyoxyethylene diols, polyoxyethylene triols, poly(oxyethylene-oxypropylene)diols and poly(oxyethylene-oxypropylene)triols.
13. The use according to embodiment 11, wherein the polycarbonate polyol is derived from at least one alkanediol selected from the group consisting of 1,4-butanediol, 1,5-pentanediol and 1,6-hexanediol.
14. The use according to embodiment 11, wherein the polyester polyol is the reaction product of at least one polyhydric alcohol and at least one compound selected from the group consisting of dicarboxylic acids, dicarboxylic esters, dicarboxylic ester anhydrides, dicarboxylic acid chlorides or lactones or the condensation product of at least one lactone.
15. The use according to embodiment 11, wherein the polyolefin polyol is selected from a polybutadiene polyol, a polyisoprene polyol, or a partially or fully hydrogenated derivative of a polybutadiene polyol and a partially or fully hydrogenated derivative polyisoprene polyol.
16. The use according to one or more of embodiments ≥1 to ≤15, wherein at least one chain extender D) is a diol having a molecular weight in the range of 50 to 399 g/mol
17. The use according to embodiment 16, wherein at least one chain extender D) is selected from the group consisting of ethylene glycol, diethylene glycol, dipropylene glycol, triethylene glycol, 1,3-propanediol, 1,4-butanediol, 1,5-pentanediol, 1,6-hexanediol, hydroquinone bis 2-hydroxyethyl ether, bis-2(hydroxyl ethyl)-terephthalate, glycerine and triethanolamine.
18. The use according to one or more of embodiments 1 to 17, wherein the mixture has a NCO:OH molar ratio in the range of ≥0.8:1.0 to ≤1.2:1.0.
19. The use according to one or more of embodiments 1 to 18, wherein the mixture further comprises at least one catalyst selected from the group consisting of tin catalysts, amine catalysts, bismuth catalysts, potassium catalysts, nickel catalysts, zirconium catalysts, zinc catalysts, aluminium catalysts and lithium catalysts.
20. The use according to embodiment 19, wherein the amine catalysts are selected from the group consisting of 5-ethyl-2-methylpyridine, 2-methylpyridine, 2,4-dimethylpyridine, 2,6-dimethylpyridine, 2,4,6-trimethylpyridine, tri-n-propylamine, tri-n-butylamine, tris-[2-(2-methoxyethoxy)ethyl]amine, 1,8-diazabicyclo[5.4.0]undec-7-ene, 1,5-diazabicyclo[4,3,0]non-5-ene, 1,8-diazabicyclo[5,3,0]dec-7-ene, 1,4-diazabicyclo[3,3,0]oct-4-ene and triethylenediamine.
21. The use according to one or more of embodiments 1 to 20, wherein the mixture further comprises at least one additive selected from the group consisting of antifoaming agents, plasticizers, water scavengers, surface-active substances, fillers, flame retardants, nucleators, oxidation inhibitors, lubricating and demolding aids, dyes and pigments, stabilizers, preferably against hydrolysis, light, heat or discoloration, organic and/or inorganic fillers and reinforcing agents.
22. The use according to embodiment 21, wherein the antifoaming agents are selected from the group consisting of silicon fluids including powdered silica dispersed therein.
23. The use according to embodiment 21, wherein the plasticizers are selected from the group consisting of aromatic carboxylates, aliphatic carboxylates and alkylsulphonic phenyl esters.
24. The use according to embodiment 21, wherein the water scavengers are selected from the group consisting of zeolite and calcium oxide
25. The use according to one or more of embodiments 1 to 24, wherein the polyurethane polymer has a dielectric volume resistivity in the range of ≥1E9 to ≤1E17 Ω*cm determined according to IEC 62631-3-1 at a voltage of 100 V and measuring resistance 60 seconds after application.
26. The use according to one or more of embodiments 1 to 25, wherein the polyurethane polymer has a shore A hardness in the range of ≥25 to ≤95 determined according to DIN ISO 7619-1.
27. The use according to one or more of embodiments 1 to 26, wherein the reaction product is
   the reaction product of
   a mixture comprising
   at least one polyisocyanate A1) and
   at least one polyol C2 and
   at least one chain extender D)
   wherein at least one polyol C2 has a weight average molecular weight in the range of ≥400 to ≤12000 g/mol determined according to DIN 55672-1
   and at least one polyol C2 has a total surface energy in the range of ≥22 to ≤50 mN/m determined according to DIN 55660-3.
28. The use according to one or more of embodiments 1 to 26, wherein the reaction product is the reaction product of
   a mixture comprising
   at least one polyisocyanate A1) and
   at least one polyol C2 and
   at least one chain extender D)
   wherein at least one polyol C2 has a weight average molecular weight in the range of 400 to ≤8000 g/mol determined according to DIN 55672-1
   and at least one polyol C2 has a total surface energy in the range of ≥22 to ≤42 mN/m determined according to DIN 55660-3.
29. A film comprising the polyurethane polymer according to one or more of embodiments 1 to 28.
30. The film according to embodiment 29, wherein the film has a thickness in the range of ≥10 to ≤250 μm.
31. The film according to embodiment 29 or 30, wherein the film has a dielectric permittivity in the range of ≥3.0 to ≤15.0 determined according to IEC 60250 at frequency of 1 kHz.
32. An electromechanical transducer comprising the film according to one or more of embodiments 29 to 31, a first electrode and a second electrode.
33. An actuator, sensor or generator comprising the electromechanical transducer according to embodiment 32.
34. An electric and/or electronic device comprising the electromechanical transducer according to embodiment 32.
35. A method for conversion of mechanical energy into electrical energy or to convert electrical energy into mechanical energy by applying voltage to a polyurethane polymer as defined in one or more of claims 1 to 28.

Embodiment 101 is a composition comprising a polyurethane being the reaction product of

a) a polyisocyanate

b) a polyol C1 and a polyol C2

c) a chain extender

eventually in the presence of a catalyst

eventually further comprising an additive

wherein the polyol C1 is a polysiloxane.

Embodiment 102 is the composition according to embodiment 101, wherein the polyol C1 and the polyol C2 have independently of one another, a total surface energy in the range of 22 to 47 mN/m determined according to DIN 55660-3.

Embodiment 103 is the composition according to embodiment 101 or 102, wherein the polyol C2 is a polyether or a polyester.

Embodiment 104 is a composition according to embodiment 101 to 103, wherein the weight ratio of the polyol C1 to polyol C2 ranges from 1:100 to 1:2, more preferably from 1:70 to 1:3, more preferably from 1:50 to 1:5.

Embodiment 105 is a composition according to any of embodiments 101 to 104, wherein the polyol C2 is polytetrahydrofurane or is a polyester based on adipidic acid, 1,4-butandiol and ethylene glycol.

Embodiment 106 is the composition according to embodiment 105, wherein the molecular weight of the polytetrahydrofuran is between 1.5×10³ and 2.5×10³ g/mol and the molecular weight of the polyester is between 1.5×10³ and 2.2×10³ g/mol.

Embodiment 7 is the composition according to any of embodiments 101 to 106, wherein the polysiloxane is polydimethylsiloxane or is a block copolymer with polydimethylsiloxane (PDMS) and ethylene oxide (EO).

Embodiment 108 is the composition according to any of embodiments 101 to 107, wherein the composition is formed to a film.

Embodiment 109 is the composition according to embodiment 108, wherein the film has a thickness between 10 μm and 5 mm.

Another aspect of the invention is the use of a composition according to any of embodiment 101 to 109 to convert mechanical energy into electrical energy or to convert electrical energy into mechanical energy

### EXAMPLES

Compounds

| | | | OH value | Surface |
|---|---|---|---|---|
| Raw | | function- | [mg | energy |
| Material | Description | ality | KOH/g] | [mN/m] |
| Polyol 1 | Polytetramethylene ether glycol (PTHF) | 2 | 112 | 39 |
| Polyol 2 | Polytetramethylene ether glycol (PTHF) | 2 | 56 | 38 |
| Polyol 3 | Propylene glycol initiated polyoxypropyelne | 2 | 56 | 32 |
| | having a polyoxypropylene content re- | | | |
| | lated to the amount of propylene oxide of | | | |
| | 93 wt- % and predominately secondary | | | |
| | hydroxyl groups. | | | |
| Polyol 4 | Bisphenol A propoxylate | 2 | 280 | 37 |
| Polyol 5 | Difunctional polyol, a block copolymer with | 2 | 62 | 20 |
| | 59 wt.- % polydimethylsiloxane (PDMS) | | | |
| | and 41 wt.- % ethylene oxide (EO) content, | | | |
| | wherein the end mainly comprises EO | | | |
| Polyol 6 | Difunctional polyol with at least 98% | 2 | 45 | 20 |
| | PDMS content | | | |
| Polyol 7 | Polybutadiene diol Krasol ® LBH P2000 | 2 | 47 | 32 |
| Polyol 8 | Polyester diol synthesized of polybutadiene | 2 | 34 | 32 |
| | diol Krasol ® LBH P2000 capped with | | | |
| | at least 30% ϵ-Caprolactone. | | | |
| Polyol 9: | Polyester diol synthesized of adipic acid, | 2 | 55 | 29 |
| | ethylene glycol and 1,4-butanediol. | | | |
| Polyol 10: | Polyester diol synthesized of a mixture of | 2 | 57 | 34 |
| | C4, C5 and C6 dicarboxylic acid with di- | | | |
| | ethylene glycol and at least 30% polyeth- | | | |
| | ylene terephthalate | | | |
| Polyol 11: | Bifunctional polyether based polyol based | 2 | 75 | 36 |
| | on polyethylene glycol | | | |
| CE 1: | 1,4-Butanediol | 2 | 1245 | / |
| AF: | Anti foaming agent PDMS with fumed silica | / | / | / |
| ZP: | Zeolite paste 50 wt- % in polyol with | / | / | / |
| | hydroxyl number of 80 mg KOH/g | | | |
| Cat 1: | Mixture of 25 wt % triethylenediamine in | / | / | / |
| | 1,4-butanediol | | | |
| Iso 1: | A prepolymer was formed from 85.7 parts | / | / | 45 |
| | by weight 4,4′-MDI, 1.2 parts by weight | | | |
| | 2,4′ MDI, 4.9 parts by weight of a | | | |
| | propylene glycol initiated polyoxypropyl- | | | |
| | ene having a polyoxypropylene content of | | | |
| | 83 wt.- % and a hydroxyl number of 248 | | | |
| | mg KOH/g, and 8.2 parts by weight | | | |
| | dipropylenene glycol. The NCO- | | | |
| | value was 23%. | | | |
| Iso 2: | Mixture of 98.6 parts by weight 4,4′-MDI | / | / | 42 |
| | and 1.4 parts by weight 2,4′-MDI having a | | | |
| | NCO-value of 33.5%. | | | |
| Iso 3: | Carbodiimide modified 4,4′-MDI with an | / | / | 45 |
| | NCO-value of 29.5%. | | | |
| Iso 4: | Diphenylmethane-4,4′-diisocyanate (MDI) | / | / | / |
| | with >3% Methylene diphenyl diisocyanate. | | | |
| Iso 5: | Mixture of 80.0 parts by weight 2,4-toluene | / | / | / |
| | diisocyanate (TDI) and 20.0 parts by | | | |
| | weight 2,6-TDI having a NCO-value of | | | |
| | 48.2%. | | | |
| Iso 6: | Tolidine diisocyanate having a NCO-value | / | / | / |
| | of 31.8%. | | | |
| Iso 7: | 4,4′-Diisocyanatodicyclohexylmethane | / | / | / |
| | having a NCO-value of 31.9%. | | | |
| Iso 8: | Hexamethylene 1,6-diisocyanate having a | / | / | / |
| | NCO-value of 50% | | | |
| Plasticizer 1: | Citric acid ester based plasticizer | / | / | |
| Plasticizer 2 | Alkane sulfonic ester based plasticizer | / | / | / |
| Polymer 1 | Polyethylene glycol (Mw 600) | / | / | 42 |
| Polymer 2 | Polyethylene glycol (Mw 4600) | / | / | /42 |
| Polymer 3 | Ultra high molecular weight polysiloxan | / | / | /20 |
| | from Dow Corning | | | |

### 2. Characterization Methods

| | |
|---|---|
| Hydroxyl value | DIN 53240 |
| Surface energy: | DIN 55660-3 |
| Shore A hardness: | DIN ISO 7619-1 |
| Elasticity modulus: | ASTM D412 |
| Volume resistivity: | IEC 62631-3-1 (measured at a |
| | voltage of 100 V and measuring |
| | resistance 60 seconds after application) |
| Dielectric | IEC 60250 (measured at frequency of 1 kHz) |
| permittivity: | |

Before the measurements, the films were stored in norm climate 23° C./50% rel. humidity in the lab for at least 72 hours.

### 3. Reference Example 1

### Preparation of Cast Elastomer and Cast Elastomer Films

The raw materials of the polyol component (polyols, chain extender, zeolith paste, anti-foaming agent and catalyst) were mixed for 120 s at 1600 RPM and degassed in vacuum using a Speedmixer™ from the company Haunschild. To the mixture a corresponding amount of degassed isocyanate component was added and mixed for 60 s at 1600 RPM using a Speedmixer™. To form cast elastomers with a thickness of 2, 6 and 10 mm, the reactive mixture was subsequently insert into a to 90° C. heated metal mold. After 60 min at 90° C. the specimen was deformed and tempered for 24 h at 90° C. within an oven (Memmert UF160 Plus). The Shore A hardness was determined using these cast elastomer plates. To form PU films with a thickness of 50 μm to 200 μm, subsequently, the reactive mixture was casted (no use of solvent!) on a PTFE film using an Erichsen film coating machine, heated to 90° C., equipped with a suitable doctor blade. The films were tempered for 24 h at 90° C. within an oven (Memmert UF160 Plus) before the mechanical and electrical performance was determined.

### 4. Reference Example 2

### Preparation of Prepolymers

For the synthesis of 1800 g prepolymer of Pre 1, Pre 2 and Pre 3, Iso 2 and, respectively, Iso 3 were charged into a four-neck round-bottom flask and heated to 60° C. When the temperature was reached, the polyol was added to the isocyanate mixture observing a temperature increase of around 5° C. Afterwards, the mixture was heated to 80° C. and heated under reflux for 2 h. It is important to consider the acidity of the mixture by adding additives well known for experts to avoid potentially occurring side reactions during the synthesis of the prepolymer. The synthesized, transparent prepolymers had a NCO-value of 9 to 18% and were stored at room temperature. After cooling, the prepolymers were still transparent.

For the synthesis of 1800 g prepolymer of Pre 4, Pre 6 and Pre 7, Iso 5 or, respectively, Iso 7 or Iso 8 was charged into a four-neck round-bottom flask and heated to 50° C. When the temperature was reached, the polyol was added to the isocyanate mixture observing a temperature increase of around 5° C. Afterwards, the mixture was heated to 80° C. and heated under reflux. After 1 h, a small amount of a tin catalyst was added and the mixture was heated under reflux for another 1 hour. It is important to consider the acidity of the mixture by adding additives well known for experts to avoid potentially occurring side reactions during the synthesis of the prepolymer. The synthesized, transparent prepolymers had a NCO-value of 18% and were stored at room temperature. After cooling, the prepolymers were still transparent.

For the synthesis of 1800 g prepolymer of Pre 5, Iso 6 was charged into a four-neck round-bottom flask, molded at 70° C. to 80° C. and heated at 70° C. When the temperature was reached, the polyol was added to the isocyanate mixture observing a temperature increase of around 10° C. Afterwards, the mixture was heated to 80° C. and heated under reflux for 2 h. It is important to consider the acidity of the mixture by adding additives well known for experts to avoid potentially occurring side reactions during the synthesis of the prepolymer. The synthesized prepolymer had a NCO-value of 18% and was stored at 50° C.

Table 1 summarizes the formulation and raw materials of the synthesized prepolymers. When used for the synthesis of cast elastomers, prepolymers were added instead of the isocyanate component as described in reference example 1.

TABLE 1
Composition of the prepolymer formulations.

| | Pre 1 | Pre 2 | Pre 3 | Pre 4 | Pre 5 | Pre 6 | Pre 7 |
|---|---|---|---|---|---|---|---|
| Polyol 2 [% by | | | | 57.6 | 38.3 | 38.5 | 59 |
| weight] | | | | | | | |
| Polyol 3 [% by | 65 | | | | | | |
| weight] | | | | | | | |
| Polyol 4 [% by | | 33 | | | | | |
| weight] | | | | | | | |
| Polyol 7 [% by | | | 40 | | | | |
| weight] | | | | | | | |
| Iso 2 [% by weight] | 29 | 61 | 54 | | | | |
| Iso 3 [% by weight] | 6 | 6 | 6 | | | | |
| Iso 5 [% by weight] | | | | 42.4 | | | |
| Iso 6 [% by weight] | | | | | 61.7 | | |
| Iso 7 [% by weight] | | | | | | 61.5 | |
| Iso 8 [% by weight] | | | | | | | 41 |
| NCO-content [%] | 9 | 15 | 18 | 18 | 18 | 18 | 18 |

### 5. Reference Example 3

### Preparation of TPU Films

Polyol, chain extender (and plasticizer) were charged into a 1-gallon metal container and preheated in an oven to 86° C. (regular) or 106° C. (hydrophobic). Fresh 4,4′ methylene diphenyl diisocyanate was poured into 500 mL plastic cup and stored at 55° C. Once the polyol mixture reached the desired temperature, it was taken out of the oven and mixed with a 4-inch diameter four-blade propeller at 700 rpm. When the temperature reached 80° C./106° C. the isocyanate was added and a timer was started. When the temperature of the mixture reached 110° C. the mixing was stopped and the content of the container was poured onto 120° C. hot plate lined with a protective film. Maximum temperature and time when it was reached as well as set time were recorded. The material could cure on the hot plate for 10 minutes and cured in an oven at 80° C. for 20 hours. In some cases, cured slabs were frozen before grinding for additional processing. The parameters of the compounding process are summarized in Table 2. Afterwards, the materials were processed on a Killion 1½″ single-screw extruder. The extruder is equipped with a DM-2 screw with a metering zone at the end and a L/D 24/1. The extruder contains 3 heating zones, heated adapter and gate and heated 8 in sheet die. The extrusion was performed according to Standard Operating Procedures. Equipment was powered on and allowed to come to the temperatures described in Table 3. A hopper was filled with a small amount of high-density polyethylene and was processed through the extruder at varying screw RPM to remove any contaminants.

Following the purge step, the experimental materials were flood fed through the hopper. In some cases, due to stickiness of the material it was manually starve fed. The melt was extruded onto chilled chromed polished rollers that were kept open. Revolutions per minute (RPMs) of the extruded and take-up rollers, AMPs, head pressure and torque were recorded. Extruded sheet was collected and cured in an oven at 80° C. for 20 hours. Extruding conditions are shown in Table 3.

TABLE 2
Twin screw compounding parameters
(mixtures, composites, additives).

| | |
|---|---|
| Zone 1 ° C. | 160-180 |
| Zone 2 ° C. | 160-180 |
| Zone 3 ° C. | 160-180 |
| Zone 4 ° C. | 160-180 |
| Zone 5 ° C. | 160-190 |
| Zone 6 ° C. | 160-190 |
| Zone 7 ° C. | 160-180 |
| Zone 8 ° C. | 160-180 |
| Zone 9 ° C. | 150-180 |
| Torque % | 10-20 |
| Melt Temp ° C. | 150-180 |
| Melt Pressure Bar | 9-20 |
| Screw RPM | 400-700 |
| Feeder #1 SP kgs./hr. | 4 |
| Cutter speed RPM | 300-700 |
| Water bath ° C. | 0-2 |

TABLE 3
Extruding conditions

| | |
|---|---|
| Zone 1 ° C. | 157-176 |
| Zone 2 ° C. | 163-188 |
| Zone 3 ° C. | 168-196 |
| Gate ° C. | 168-196 |
| Adaptor ° C. | 168-196 |
| Die (6) ° C. | 163-193 |
| Torque bar | 5-90 |
| Head Press. bar | 21-50 |
| Screw RPM | 15-40 |
| Take-up RPM | 1.2-7.0 |
| Amps | 3.5-10.5 |
| Melt Temp. ° C. | 177-204 |

### 6. Preparation of Cast Elastomer Films and Determination of Mechanical and Electrical Performance

Cast elastomers based on polyether and polyester were synthesized according to the description of reference examples 1 and 2. The mechanical and electrical properties were determined with the above described characterization methods. The following tables 4 to 5 show the used raw materials, formulation and determined properties of the cast elastomers, table 6 to 7 summarize the findings for TPU films. Exemplarily, the electrical results were determined using a casted film with a thickness of 200 μm.

TABLE 4
Investigation of isocyanate types in polyether based cast elastomers
and the results of the mechanical and electrical characterization.

| | 1a | 1b | 1c | 1d | 1e |
|---|---|---|---|---|---|
| Polyol 2 | 93.3 | 93.3 | 93.3 | 93.3 | 93.3 |
| [wt.- %] | | | | | |
| CE 1 [wt.- %] | 3.0 | 3.0 | 3.0 | 3.0 | 3.0 |
| AF [wt.- %] | 0.5 | 0.5 | 0.5 | 0.5 | 0.5 |
| ZP [wt.- %] | 3.0 | 3.0 | 3.0 | 3.0 | 3.0 |
| Cat 1 [wt.- %] | 0.2 | 0.2 | 0.2 | 0.2 | 0.2 |
| Iso 1 [wt.- %] | X | | | | |
| Pre 4 [wt.- %] | | X | | | |
| Pre 5 [wt.- %] | | | X | | |
| Pre 6 [wt.- %] | | | | X | |
| Pre 7 [wt.- %] | | | | | X |
| Index | 102 | 102 | 102 | 102 | 102 |
| Shore A | 60 | 56 | 83 | 64 | 66 |
| hardness | | | | | |
| Volume | 9.9 × 10¹⁰ | 2.3 × 10¹¹ | 2.0 × 10¹¹ | 2.0 × 10¹¹ | 6.8 × 10¹⁰ |
| resistivity | | | | | |
| [Ω * cm] | | | | | |
| Dielectric | 7.3 | 6.6 | 5.5 | 6.0 | 7.4 |
| permittivity | | | | | |
| (1 kHz) | | | | | |

TABLE 5
Composition of the formulation for polyether based cast elastomers and the results
of the mechanical and electrical characterization.

| | 1 | 2 | 3 | 4 | 5 | 6 | 6a** | 7 | 7a** | 7b** | 8 | 9 |
|---|---|---|---|---|---|---|---|---|---|---|---|---|
| Polyol 1 [wt.-%] | 93.3 | 93.3 | | | | | | | | | | |
| Polyol 2 [wt.-%] | | | 93.3 | 93.3 | 93.3 | 83.2 | | 83.2 | | | 93.2 | 83.2 |
| Polyol 5 [wt.-%] | | | | | | 10.0 | 93.3 | | | 43.3 | | |
| Polyol 6 [wt.-%] | | | | | | | | 10.0 | 93.3 | 50.0 | | |
| Polyol 8 [wt.-%] | | | | | | | | | | | | 10.0 |
| CE 1 [wt.-%] | 3.0 | 3.0 | 3.0 | 3.0 | 3.0 | 3.0 | 3.0 | 3.0 | 3.0 | 3.0 | 3.0 | 3.0 |
| AF [wt.-%] | 0.5 | 0.5 | 0.5 | 0.5 | 0.5 | 0.5 | 0.5 | 0.5 | 0.5 | 0.5 | 0.5 | 0.5 |
| ZP [wt.-%] | 3.0 | 3.0 | 3.0 | 3.0 | 3.0 | 3.0 | 3.0 | 3.0 | 3.0 | 3.0 | 3.0 | 3.0 |
| Cat 1 [wt.-%] | 0.2 | 0.2 | 0.2 | 0.2 | 0.2 | 0.3 | 0.3 | 0.3 | 0.3 | 0.3 | 0.3 | 0.3 |
| Iso 1 [wt.-%] | X | X | X | | | X | X | X | X | X | | X |
| Pre 1 [wt.-%] | | | | X | | | | | | | | |
| Pre 2 [wt.-%] | | | | | X | | | | | | | |
| Pre 3 [wt.-%] | | | | | | | | | | | X | |
| Index | 102 | 90 | 102 | 102 | 102 | 100 | 102 | 100 | 102 | 102 | 102 | 102 |
| Shore A hard- | 60 | 40 | 60 | 60 | 60 | 60 | failed | 60 | failed | failed | 65 | 63 |
| ness | | | | | | | | | | | | |
| Volume | 1.0 × | 3.5 × | 9.9 × | 6.0 × | 1.4 × | 8.8 × | failed | 1.2 × | failed | failed | 2.8 × | 4.3 × |
| resistivity [Ω*cm] | 10¹¹ | 10¹⁰ | 10¹⁰ | 10¹⁰ | 10¹¹ | 10¹⁰ | | 10¹¹ | | | 10¹¹ | 10¹¹ |

**not within scope/n.d.: not determined
X: the respective raw materials used, the amount can be calculated via the index
The index describes the molar ration of NCO groups to reactive hydroxyl groups; an index of 100 relates to a ratio of 1:1. An index higher than 100 describes an excess of isocyanate groups; an index below 100 describes an excess of reactive hydroxyl groups.

TABLE 6
Composition of the formulation for polyether based TPU films
and the results of the mechanical and electrical characterization.

| | 12 | 13 | 14 |
|---|---|---|---|
| Polyol 1 [wt.- %] | 56 | | |
| Polyol 2 [wt.- %] | | 61.7 | |
| Polyol 11 [wt.- %] | | | 51.9 |
| CE [wt.- %] | 7.1 | 3.8 | 1.1 |
| Iso 4 [wt.- %] | X | X | X |
| Plasticizer [wt.- %] | | 15 | |
| Index | 100 | 100 | 100 |
| Shore A hardness | 85 | 60 | 85 |
| elasticity modulus [MPa] | 24.6 | 8.9 | 24.6 |
| Volume resistivity [Ω * m] | 5.1 × 10¹¹ | 7.1 × 10¹⁰ | 4.0 × 10⁹ |
| Dielectric permittivity (1kHz) | 6.7 | 7.6 | 10 |

X: the respective raw materials used, the amount can be calculated via the Index
The Index describes the molar ration of NCO groups to reactive hydroxyl groups; an index of 100 relates to a ratio of 1:1. An index higher than 100 describes an excess of isocyanate groups; an Index below 100 describes an excess of reactive hydroxyl groups.
n.d.: not determined

TABLE 7
Composition of the formulation for polyester based TPU films and
the results of the mechanical and electrical characterization.

| | 15 | 16 | 17 |
|---|---|---|---|
| Polyol 5 [wt.- %] | | 2.7 | 5.5 |
| Polyol 9 [wt.- %] | 54.8 | 52 | 49.3 |
| CE [wt.- %] | 4.6 | 4.6 | 4.6 |
| Iso 4 [wt.- %] | X | X | X |
| Plasticizer [wt.- %] | 15 | 15 | 15 |
| Index | 100 | 100 | 100 |
| Shore A hardness | 45 | n.d. | n.d. |
| elasticity modulus [MPa] | 4.8 | 2.2 | 1.4 |
| Volume resistivity [Ω * m] | 4.9 × 10¹¹ | 6.2 × 10¹¹ | 2.2 × 10¹¹ |
| Dielectric permittivity (1 kHz) | 4.9 | 7.0 | 6.7 |

X: the respective raw materials is used, the amount can be calculated via the Index
The Index describes the molar ration of NCO groups to reactive hydrogen atoms; an index of 100 relates to a ratio of 1:1. An index higher than 100 describes an excess of isocyanate groups; an Index below 100 describes an excess of reactive hydrogen atoms.
n.d.: not determined

With polyether-based TPU, it was demonstrated that the type of polyol had a large impact on electrical properties while an increased ratio of polyol to isocyanate or lower “hardness” did not have as significant increase of dielectric permittivity or decrease of volume resistivity. Furthermore, for the polyester-polyol based TPU a second polyol of different chemical makeup was added to demonstrate the lower limits of elasticity modulus. In fact, while adding up to 20% replacement of the polyester polyol with a PDMS-based polyol, a 30% reduction of the elasticity modulus was realized with a simultaneous 30% increase in dielectric permittivity.

TABLE 8
Composition of the formulation for blended TPU films and
the results of the mechanical and electrical characterization.

| | 18** | 19** | 20 | 21 | 22 | 23 |
|---|---|---|---|---|---|---|
| Polyol 9 [wt.-%] | 54.8 | 54.8 | 54.8 | 54.8 | 54.8 | 54.8 |
| CE [wt.-%] | 4.6 | 4.6 | 4.6 | 4.6 | 4.6 | 4.6 |
| Iso 4 [wt.-%] | X | X | X | X | X | X |
| Plasticizer 1 [wt.-%] | 15 | 15 | 15 | 15 | 15 | 15 |
| Polymer 3 [wt.-%] | 5 | 15 | | | | |
| Polymer 1 [wt.-%] | | | 10 | 30 | | |
| Polymer 2 [wt.-%] | | | | | 10 | 30 |
| Index | 100 | 100 | 100 | 100 | 100 | 100 |
| Shore A hardness | n.d | n.d | n.d | n.d | n.d | n.d |
| E-Modulus [MPa] | | | 4.6 | 4.2 | 6.1 | 3.8 |
| Volume resistivity | n.d. | n.d. | 5.2 × | 6.6 × | 1.5 × | n.d. |
| [Ω*cm] | | | 10¹⁰ | 10¹⁰ | 10¹⁰ | |
| Dielectric | n.d | n.d | 7.1 | 6.3 | 6.9 | n.d. |
| permittivity | | | | | | |
| (1 kHz) | | | | | | |

**not within scope/n.d.: not determined

For polymer blends with poly(ethylene glycol) (PEG), significant differences from the standard TPU were not found. In general, the dielectric permittivity decreased with higher content of compounded PEG, and volume resistivity was not affected. Though the polarity and surface energy of polyethylene glycol is relatively high, none of the improved dielectric effects were realized. This result further substantiates the necessity to incorporate polar materials into the matrix backbone. When ultrahigh molecular weight poly(siloxane) was compounded into TPU and films extruded, the polarity difference became too high to produce a film of good enough quality to obtain a measurement.

1. A composition, comprising a polyurethane comprising, in reacted form:
a polyisocyanate;
a polysiloxane polyol C1;
a polyol C2;
a diol or triol chain extender having a molecular weight less than 400 g/mol, and
optionally, an additive,
wherein the polyurethane is optionally reacted in the presence of a catalyst,
wherein a weight ratio of the polyol C1 to polyol C2 is in a range of from 1:70 to 1:3, and
wherein the polyol C1 has a structure of formula (I) 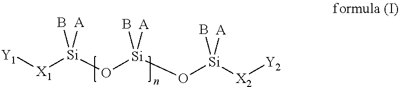
wherein
n is an integer in a range of from 1 to 250,
A and B are independently a C1-C20 alkyl group,
X₁ is (CH₂—CH₂—O)ₘ, (CH₂—CH₂—CH₂—O)ₘ, (CH₂—CHCH₃—O)ₘ, (CH₂)ₘ—O, or (CH₂)ₘ,
X₂ is (O—CH₂—CH₂)ₘ, (O—CHCH₃—CH₂)ₘ, (O—CH₂—CH₂—CH₂)ₘ, O—(CH₂)ₘ, or —(CH₂)ₘ,
m for X₁ and X₂ is independently an integer in a range of from 1 to 100, and
Y1 and Y2 are independently a thiol group, hydroxyl group, or amino group.

2. The composition of claim 1, wherein the polyol C1 and the polyol C2 have independently of one another, a total surface energy in a range of from 22 to 47 mN/m, determined according to DIN 55660-3.

3. The composition of claim 1,
wherein the polyol C2 is a polyether.

4. The composition of claim 1,
wherein the weight ratio of the polyol C1 to polyol C2 is in a range of from 1 to 50 to 1:5.

5. The composition of claim 1,
wherein the polyol C2 is polytetrahydrofurane.

6. The composition of claim 5,
wherein the polytetrahydrofuran has a molecular weight in a range of from 1.5×10³ to 2.5×10³ g/mol.

7. The composition of claim 1,
wherein the polysiloxane polyol C1 is polydimethylsiloxane.

8. The composition of claim 1,
wherein the composition is suitable to form a film.

9. A film, made from the composition of claim 1,
wherein the film has a thickness in a range of from 10 μm to 5 mm.

10. A method of converting mechanical energy into electrical energy or converting electrical energy into mechanical energy, the method comprising:
contacting a source of the mechanical or electrical energy with the composition of claim 1.

11. The composition of claim 1, wherein the polyol C2 is a polyester.

12. The composition of claim 1, wherein the polyol C2 is a polyester comprising, in reacted form, adipidic acid, 1,4-butandiol, and ethylene glycol

13. The composition of claim 12, wherein the polyester has a molecular weight in a range of from 1.5×10³ to 2.2×10³ g/mol.

14. The composition of claim 1, wherein the polysiloxane polyol C1 is a block copolymer, comprising, in polymerized form:
polydimethylsiloxane; and
ethylene oxide.

15. The composition of claim 1, wherein the chain extender is a diol.

16. The composition of claim 1, wherein the chain extender is a triol.

17. The composition of claim 1, wherein the polyisocyanate is a prepolymer having an NCO content in a range of from 8 to 31.5%.

18. The composition of claim 17, wherein the prepolymer comprises, in reacted form, the polyisocyanate and the polyol C2 at a ratio of isocyanate groups to hydroxyl groups of 2:1 to 20:1.
